(19) United States
(12) Patent Application Publication
(10) Pub. No.: US 2014/0047075 A1
(43) Pub. Date: Feb. 13, 2014

(54) COMPLEMENTING CONSUMPTION OF MEDIA CONTENT USING A DISPLAY DEVICE WITH A MOBILE DEVICE

(71) Applicants: Jiqiang Song, Beijing (CN); Wenlong Li, Beijing (CN)

(72) Inventors: Jiqiang Song, Beijing (CN); Wenlong Li, Beijing (CN)

(21) Appl. No.: 13/996,481

(22) PCT Filed: Mar. 30, 2012
(86) PCT No.: PCT/CN2012/073326

§ 371 Date: Oct. 28, 2013

(51) Int. Cl. G06F 17/30

(52) U.S. Cl. CPC G06F 17/30058
USPC 709/219

(57) ABSTRACT

Apparatuses, storage medium and methods associated with emulating a storage medium with media files to a display device are disclosed herein. In embodiments, an adapter device may include a peripheral interface to couple the adapter device to the display device emulating the storage medium. The adapter device may further include one or more logic units coupled to the peripheral interface to provide the display device with a playlist of one or more media files (established on instructions of a mobile device), and in response to a selection of one of the one or more media files by the display device, provide the display device with media content associated with the selected media file, emulating the storage medium. In embodiments, the one or more logic units may capture one or more images for the mobile device to conduct online transactions. Other embodiments may be disclosed or claimed.

### TECHNICAL FIELD

This application relates to the technical field of digital data processing, more specifically to methods and apparatuses associated with completing consumption of media content using a display device with a mobile device.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Interacting with television (TV) using handy smart devices, like smartphone or tablet, provides TV viewers with a fascinating experience. Today, a few high-end smart TVs and set-top boxes (STBs) include integrated support for such interaction with handy smart devices. However, for most consumers, upgrading their TVs or STBs is not a good option, due to economic and other reasons.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an arrangement configured to enable a smart mobile device to complement consumption of media content using a non-smart display device, through usage of an adapter device emulating a storage medium with one or more media files under control of the smart mobile device;

FIG. 2 illustrates a method of the arrangement of FIG. 1; and

FIG. 3 illustrates an example computer-readable storage medium having instructions configured to practice all or selected aspects of the method of FIG. 2; all arranged in accordance with embodiments of the present disclosure.

### DETAILED DESCRIPTION

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”.

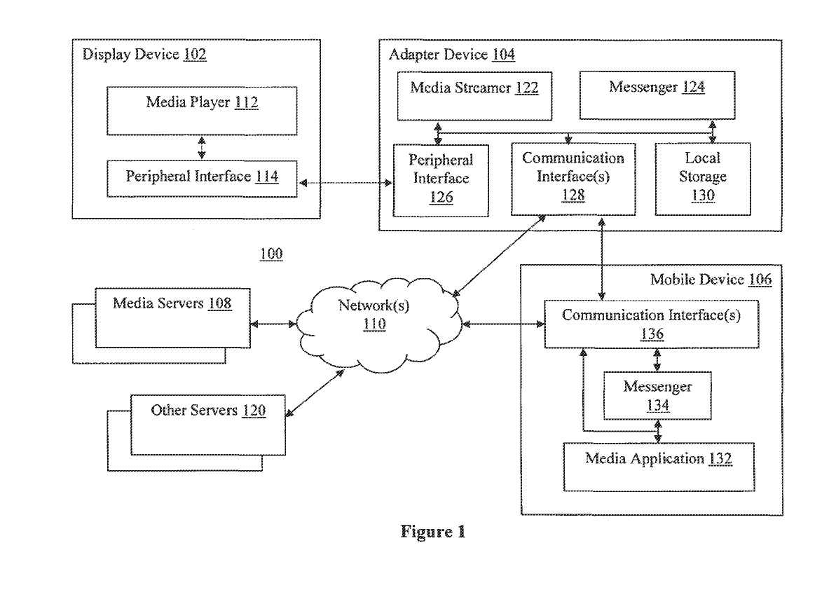

FIG. 1 illustrates an arrangement configured to enable a smart mobile device to complement consumption of media content using a non-smart display device, through usage of an adapter device emulating a storage medium with one or more media tiles under control of the smart mobile device, in accordance with various embodiments. As illustrated, arrangement 100 may include display device 102, adapter device 104, mobile device 106, communicatively coupled with each other as shown. For the embodiments, adapter device 104 and mobile device 106 may be communicatively coupled with media servers 108 and/or other servers 120, via network(s) 110, as shown. As will be described in more detail below, adapter device 104 and mobile device 106 may be configured to enable a user of mobile device 106 to use mobile device 106 to complement consumption of media content using display device 102, through usage of adapter device 104 emulating a storage medium with one or more media files under control of mobile device 106. Accordingly, display device 102 may be a conventional non-smart display device, such as a conventional non-smart TV, having the capability of accepting a storage medium with media files, and play the media tiles on the storage medium. Thus, a user of mobile device 106 may enjoy the enhanced content consumption experience without having to upgrade display device 102 to a smart display device or the STB associated with display device 102 to a smart STB. Also, for manufacturers of display device 102, decoupling the display function and general computing and networking function may be an attractive option for easier after-sale service and better adaptation to fast evolving Internet applications.

As shown, in embodiments, non-smart display device 102 (hereinafter, simply display device) may include media player 112 and peripheral interface 114. Media Player 112 is intended to represent a broad range of player components configured to play media files, known in the art. Peripheral interface 114, as alluded to earlier, may be configured to accept a storage medium with one or more media files. In embodiments, peripheral interface 114 may be configured to removably accept a memory card or a flash drive, Examples of memory card or flash drive, may include, but are not limited to, Compact Flash from SanDisk Corp., SmartMedia from Toshiba Corp., Multi Media Card from Sieman Corp., Secure Digital (SD) from Panasonic Corp., Memory Stick from Sony Corp., and so forth. In embodiments, peripheral interface 114 may be configured to removably accept a SD card. In alternate embodiments, peripheral interface 114 may be configured to removably accept a USB (Universal Serial Bus) storage device; and use a USB-to-SD adapter to accept a SD card.

In alternate embodiments, media player 112 and peripheral interface 114, instead of being disposed in display device 102, may be disposed on other devices coupled to display device 102 instead, Such other devices may include, but are not limited to, DVD players, set-top boxes (STBs), and so forth.

In embodiments, adapter device 104 may include one or more logic units 122 and 124, peripheral interface 126, one or more communication interface(s) 128 and local storage 130, coupled with each other as shown. In embodiments, logic units 122 and 124 may include media streamer 122 and messenger 124.

In embodiments, adapter device 104 and peripheral interface 126 may be complementarily configured to mate with display device 102 and peripheral interface 114, and emulate a storage medium with one or more media files to display device 102. For example, if target display device 102 is configured to removably accept a SD, adapter device 104 may have the form factor of a SD, and peripheral interface 126 may comprise a SD interface. Further, peripheral interface 126 may include interface logic that enables adapter device 104 to emulate and appear as a SD to display device 102.

In embodiments, communication interface(s) 128 may include a wireless local area network interface to communicatively couple adapter device 104 with mobile device 106, and with media servers 108 via an access point (not shown) and network(s) 110. An example of a wireless local area network interface may be a WiFi® interface in compliance with one of the IEEE 802.11 standards. (IEEE=Institute of Electrical and Electronic Engineers.) In alternate embodiments, communication interface(s) 128 may include a wireless personal network interface to communicatively couple adapter device 104 with mobile device 106 instead. An example of a wireless personal network interface may be a Bluetooth® interface. In still other embodiments, communication interface(s) 128 may include a wireless wide area network interface to communicatively couple adapter device 104 with media servers 108 via network(s) 110 instead. An example of a wireless wide area network interface may be a 3G or 4G telecommunication interface. (3G and 4G refer to the 3^{rd} and 4^{th} Generation of Mobil Telecommunication Standards as defined by International Telecommunication Union.)

In embodiments, messenger 124 may be configured to receive instructions from mobile device 106. Instructions may direct inclusion of one or more titles of one or more media tiles in a playlist to be presented to display device 102. The media tiles may be one or more movies, one or more songs, or one or more episodes of a show, e.g., a television show. In embodiments, the instructions may include locations where adapter device 104 may retrieve media content associated with the one or more media files. Locations may include e.g., file paths on mobile device 106, or uniform resource locators including information identifying media servers 108. Instructions may further include instructions for media operations, like grabbing an image, modifying contents, and so forth, with respect to a media file, e.g., the media file being provided to and displayed on display device 102.

In embodiments, media streamer 122 may be configured to retrieve the media content associated with a media file selected for playing by display device 102, and provide the media content to display device 102 through peripheral interface 126, emulating a storage medium with one or more media files. In embodiments, media streamer 122 may retrieve the media content associated with the selected media file on selection. In embodiments, media streamer 122 may pre-retrieve and cache at least a portion of the media content associated with a media file prior to selection for playing by display device 102. In embodiments, media streamer 122 may discard the media content upon provision to display device 102. In alternate embodiments, media streamer 122 may retain the media content for a period in accordance with one or more operation policies after provision to display device 102. In embodiments, media streamer 122 may also be able to perform media operations, like capturing image, modifying contents, and so forth, for a medial file, e.g., the media file being provided to and displayed on display device 102.

In particular, media streamer 122 may be configured to capture one or more images of the media content of a media file, while the media content is provided to and being played by display device 102. The capturing of the one or more images may be responsive to instructions received (e.g., through messenger 124) from mobile device 106. The captured one or more images may be provided (e.g., through messenger 124) to mobile device 106 to enable the one or more images to be used as basis for one or more online transactions using mobile device 106. Such one or more online transactions may complement consumption of the media content using display device 102.

In embodiments, media streamer 122 and messenger 124 may be implemented in hardware, e.g., with application specific integrated circuit (ASIC) or programmable integrated circuits, such as, field programmable gate arrays (FPGA) programmed with the operational logic. In embodiments, media streamer 122 and messenger 124 may be implemented in software, e.g., with instructions to be executed by one or more processors or processor cores (not shown). In embodiments, media streamer 122 and messenger 124 may be combined. In other embodiments, the functions of media streamer 122 and messenger 124 may be further sub-divided.

In embodiments, local storage 130 may be configured to store the playlist, the media content, and other related data. In embodiments, local storage 130 may be non-volatile persistent storage, e.g., flash memory or a solid state disk.

In embodiments, mobile device 106 may include one or more logic units 132 and 134, and communication interface(s) 136, coupled with each other as shown. In embodiments, one or more logic units 132 and 134 may include media application 132 and messenger 134.

In embodiments, communication interface(s) 136 may include a wireless local area network interface to communicatively couple mobile device 106 with adapter device 104, and with media servers 108 via an access point (not shown) and network(s) 110. An example of a wireless local area network interface may be a WiFi® interface in compliance with one of the IEEE 802.11 standards. (IEEE=Institute of Electrical and Electronic Engineers.) In alternate embodiments, communication interface(s) 136 may include a wireless personal network interface to communicatively couple mobile device 106 with adapter device 104 instead. An example of a wireless personal network interface may be a Bluetooth® interface. In still other embodiments, communication interface(s) 136 may include a wireless wide area network interface to communicatively couple media servers 108 with adapter device 104 via network(s) 110 instead. An example of a wireless wide area network interface may be a 3G or 4G telecommunication interface. (3G and 4G refer to the 3^{rd} and 4^{th} Generation of Mobil Telecommunication Standards as defined by International Telecommunication Union.)

In embodiments, messenger 134 may be configured for use to provide instructions to adapter device 104. Instructions may direct inclusion of one or more titles of one or more media files in a playlist to be presented to display device 102. As described earlier, the media tiles may be one or more movies, one or more songs, or one or more episodes of a show, e.g., a television show. In embodiments, the instructions may include locations where adapter device 104 may retrieve media content associated with the one or more media files. Locations may include e.g., file paths on mobile device 106, or uniform resource locators including information identifying media servers 108. Messenger 134 may be employed to provide the titles and the locations of the media files from time to time. Messenger 134 may also be used to send instructions for media operations, like grabbing an image, modifying contents, and so forth, for a media file, e.g., the media file being provided to display device 102 to display.

In embodiments, media application 132 may be configured to facilitate a user of mobile device 106 to use mobile device 106 to complement consumption of media content using display device 102. In embodiments, media application 132 may be configured to enable a user in browsing and/or selecting available media files from media servers 108. Media application 132 may be further configured to enable the user to instruct adapter device 104 (e.g., through messenger 134) with respect to one or more titles of one or more media files to be included in a playlist to be presented to display device 102 emulating a storage medium. Media application 132 may also be configured to enable the user to provide adapter device 104 (e.g., through messenger 134) with one or more locations to retrieve media content of the one or more media files for provisioning to display device 102 emulating a storage medium. As described earlier, the titles and the locations of the media files may be provided to adapter device 104 from time to time.

In embodiments, media application 132 may be configured to provide instructions (e.g., through messenger 134) to adapter device 104 to capture one or more images of the media content of a media file, while the media content is provided to and being played by display device 102. As described earlier, the captured one or more images may be provided (e.g., through messenger 134) to media application 132 to enable the one or more images to be used as a basis for one or more online transactions with one or more other servers 120 using mobile device 106.

In embodiments, the online transactions may include transactions with, e.g., a remote search engine, to acquire additional information associated with the one or more images or portions thereof. Portions of an image may include, but are not limited to, e.g., a person, a character, a clothing item, or an article in the image. Thus, the online transactions may also include transactions with an e-commerce site, to acquire one or more articles in the one or more images. Similarly, the online transactions may also include transactions with e.g., a social network site, to upload and annotate the one or more images or portions thereof.

Such one or more online transactions may complement consumption of the media content using display device 102, providing a user of display device 102 with enhanced consumption experience.

In embodiments, media application 132 and messenger 134 may be implemented in hardware, e.g., with application specific integrated circuit (ASIC) or programmable integrated circuits, such as, field programmable gate arrays (FPGA) programmed with the operational logic. In embodiments, media application 132 and messenger 134 may be implemented in software, e.g., with instructions to be executed by one or more processors or processor cores (not shown). In embodiments, media application 132 and messenger 134 may be combined. In other embodiments, the functions of media application 132 and messenger 134 may be further sub-divided.

Media servers 108 are intended to represent servers associated with a broad range of media sources. Example of media sources may include Netflix® of Los Gatos, Calif., or Hulu of Los Angeles, Calif.

As alluded to earlier, other servers 120 are intended to represent servers associated with a broad range of search engine, social networking and/or e-commerce websites. Example of such websites may include, but are not limited to, Google®, Facebook®, and Amazon®.

Network(s) 110 are intended to represent a broad range of wired or wireless, local or wide area networks, private or public, including e.g., the Internet.

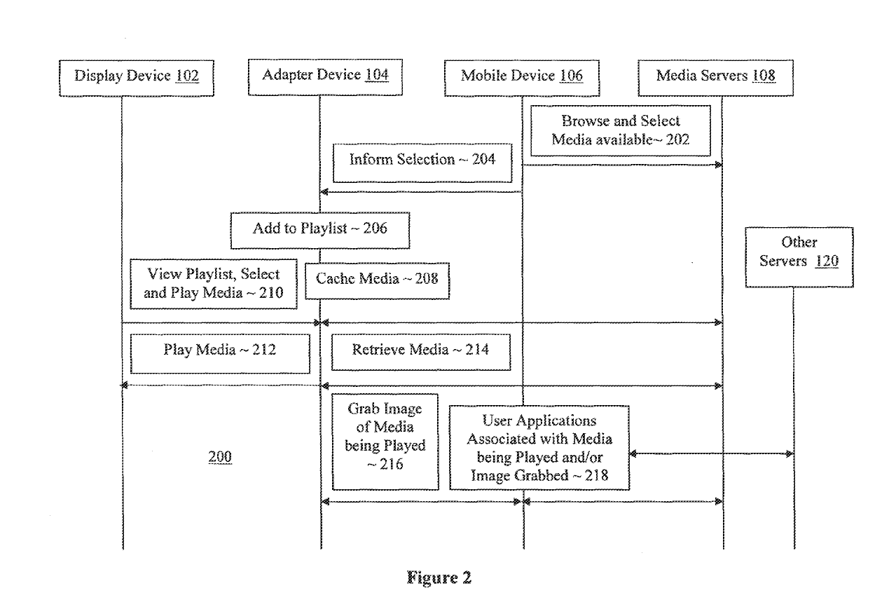

FIG. 2 illustrates a method of the arrangement of FIG. 1, in accordance with various embodiments. As shown, method 200 may begin at block 202. At block 202, mobile device 106 may facilitate a user in browsing media servers 108 to determine and/or select media files with media content available for consumption. From block 202, method 200 may proceed to block 204. At block 204, mobile device 106 may instruct adapter device 104 to include the media files in a playlist to be presented to display device 102 emulating a storage medium. Adapter device 104 may or may not have been removably mated with display device 102. Mobile device 106 may further provide adapter device 104 with locations of the one or more media files. In embodiments, blocks 202 and 204 may be repeated from time to time.

From block 204, method 200 may proceed to block 206. At block 206, adapter device 104 may add the media files to the playlist to be presented to display device 102 as instructed. From block 206, method 200 may proceed to block 208, then block 210, or to block 210 directly. At block 208, adapter device 104 may pre-retrieve and cache at least a portion of each of the media file included in the playlist. At block 210, after removably mating adapter device 104 with display device 102, a user may view the playlist using display device 102. As described earlier, media player 112 may access adapter device 104 to retrieve the playlist as if adapter device 104 is a storage medium. In response, after detecting removable mating with display device 102, adapter device 104 may provide the playlist to display device 102 emulating a storage medium, in response to access by display device 102. From block 210, method 200 may proceed to block 212. At block 212, a user may interact with display device 102, select and play one of the media files in the playlist. As described earlier, media player 112 may access adapter device 104 to retrieve the media content of the selected media file as if adapter device 104 is a storage medium. From block 212, method 200 may proceed to block 214. At block 214, adapter device 104 may retrieve (if not previously retrieved) and provide the media content of the selected media file to display device 102 emulating a storage medium

From block 214, method 200 may proceed to block 216. At block 216, while media content of the selected media file is being played and consumed, in response to instructions from mobile device 106, adapter device 104 may capture one or more images of the media content being played and provides the captured one or more images to mobile device 106. From block 216, method 200 may proceed to block 218. At block 218, mobile device 106 may facilitate a user of mobile device 106 in engaging one of the other servers 120 in an online transaction, based at least in part on the one or more images, or portion thereof, as described earlier.

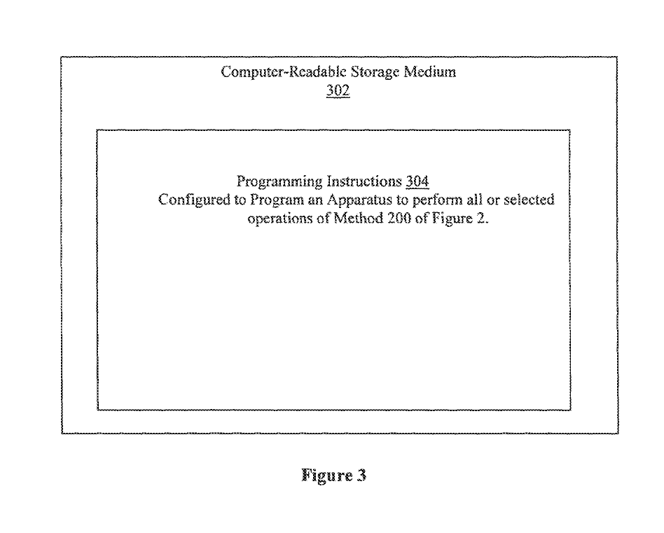

FIG. 3 illustrates an example computer-readable storage medium having instructions configured to practice all or selected aspects of the method of FIG. 2; in accordance with various embodiments of the present disclosure. As illustrated, computer-readable storage medium 302 may include a number of programming instructions 304. Programming instructions 304 may be configured to enable a computing device to perform the adapter device operations or the mobile device operations of method 200 earlier described with references to FIG. 2. In alternate embodiments, programming instructions 304 may be disposed on multiple computer-readable storage media 302 instead. In various embodiments, computer-readable storage medium 302 may be a non-transitory storage medium.

Referring back to FIG. 1, for one embodiment, a processor (not shown) of adapter device 104 or mobile device 106 may be packaged together with computational logic configured to practice the corresponding adapter device operations or mobile device operations of method 200 of FIG. 2. For one embodiment, the processor may be packaged together with such computational logic to form a System in Package (SiP). For one embodiment, the processor may be integrated on the same die with such computational logic. For one embodiment, the processor may be integrated on the same die with such computational logic to form a System on Chip (SoC). For at least one embodiment, the SoC incorporated with computing logic of the adapter device operations may be utilized in a memory card. For at least another embodiment, the SoC incorporated with computing logic of the mobile device operations may be utilized in a smartphone, cell phone, tablet, or other mobile device.

In embodiments, the computing logic on adapter device 104 may be updated, according to a configured schedule or triggered by mobile device 106.

In summary, the embodiments described herein include, but are not limited to, an apparatus (e.g., an adapter device) for enabling consumption of media content using a display device and complementing the consumption using a mobile device. The apparatus may include a peripheral interface to couple the apparatus to the display device, emulating a storage medium having one or more media files; and one or more logic units coupled to the peripheral interface to provide the display device with a playlist of the one or more media files. The one or more logic units further, in response to a selection of one of the one or more media files by the display device, provide the display device with media content associated with the selected media file emulating the storage medium. Additionally, the one or more logic units are to establish the playlist of one or more media files responsive to instructions from the mobile device, and to retrieve the media content associated with the selected media file from the mobile device or a remote media server identified by the mobile device.

In embodiments, the apparatus may further include one or more communication interfaces coupled to the one or more logic units to enable the one or more logic units to receive the instructions with respect to establishment of the playlist from the mobile device, or to retrieve the media content associated with the selected media file from the mobile device or the remote media server. In embodiments, the apparatus may further include a local storage coupled to the communication interface and the one or more logical units to enable the one or more logical units to pre-cache at least a portion of the media content associated with the selected media file, after receipt of instructions from the mobile device to include the media file as part of the playlist.

In embodiments, the one or more logic units are to further capture one or more images of the media content of the selected media file, in response to instructions from the mobile device, while the media content is provided to the display device and played by the display device. In embodiments, the one or more logic units may include a messenger to receive the instructions from the mobile device; and a media streamer to provide the display device with the playlist of one or more media files, to receive the selection of one of the one or more media files from the display device, and to provide the display device with media content associated with the selected media file, including retrieval of the media content associated with the selected media file from the mobile device or the remote media server.

In embodiments, the display device may be a television having a complementary peripheral interface to enable the apparatus to be removably coupled with the television through the peripheral interface of the apparatus, and the one or more media files may include one or more movies or one or more episodes of a show. In embodiments, the local storage may be a non-volatile persistent storage. The one or more communication interfaces may include one or more wireless communication interfaces, including a wireless personal network communication interface, a wireless local area communication interface, or a wireless wide area network communication interface. The storage medium may emulate a memory card.

The embodiments described herein further include, but are not limited to, a complementary apparatus (e.g., a mobile device) for complementing consumption of media content using a display device. The complementary apparatus may include a communication interface to communicatively couple the complementary apparatus with an adapter device configured to emulate a storage medium having one or more media files to the display device; and one or more logical units coupled to the communication interface to instruct the adapter device to capture one or more images from media content of a media file being provided from the adapter device to the display device to play, while the media content is being played by the display device, and provide to the apparatus with the one or more images after capture. The complementary apparatus may further facilitate one or more online transactions involving the one or more images or portions thereof. In embodiments, the one or more online transactions may include one or more transactions with a remote search engine, an online social networking site, or an online e-commerce site.

In embodiments, the one or more logical units are to further instruct the adapter device to include the one or more media files in a playlist to be presented to the display device emulating the storage medium, and to provide the adapter device with one or more locations to retrieve media content associated with the one or more media files, to enable the adapter device, in response to a selection of one of the one or more media files by the display device, to provide the display device with the media content associated with the selected media file emulating the storage medium.

In embodiments, the one or more logical units may include a messenger unit to instruct the adapter device to include one or more media files in a playlist to be presented to the display device, and to provide the adapter device with one or more locations to retrieve media content associated with the one or more media files; and a user application to enable a user to identify the one or more media files, to provide instructions to capture one or more images of the media content of the selected media file, through the adapter device, while the media content is being played by the display device, and to facilitate one or more transactions involving the one or more images or portions thereof. The messenger unit may further instruct the adapter device to capture the one or more images.

In embodiments, the user application may facilitate the one or more transactions involving the one or more images or portions thereof through the communication interface, with the communication interface being a wireless local network communication interface. In embodiments, the communication interface may be a wireless personal network communication interface, with the messenger unit instructing the adapter device through the wireless personal network communication interface, and the complementary apparatus further include a wireless local area network communication interface, with the user application facilitating the one or more transactions involving the one or more images or portions thereof through the wireless local area network communication interface.

In embodiments, the complementary apparatus may be a smartphone or a computing tablet. The display device may be a television having a peripheral interface to enable removable mating with the adapter device, and the one or more media files may include one or more movies or one or more episodes of a show.

The embodiments described herein further include, but are not limited to, at least one computer-readable storage medium having a number of instructions configured to enable an adapter device, in response to execution of the instructions by the adapter device, to emulate a storage medium with media files to a display device to enable consumption of the media files using the display device and complementing the consumption using a mobile device. The adapter device may be enabled to provide to the display device a playlist of one or more media files, and in response to a selection of one of the one or more media files by the display device, provide to the display device with media content associated with the selected media file emulating the storage medium. Further, the adapter device may be enabled to establish the playlist of one or more media files responsive to instructions from the mobile device, and to retrieve the media content associated with the selected media file from the mobile device or a remote media server identified by the mobile device.

In embodiments, the adapter device may be further enabled to pre-cache at least a portion of the media content associated with the selected media file from the remote media server, after receipt of instructions from the mobile device to include the media file as part of the playlist. The adapter device may be further enabled to capture one or more images of the media content of the selected media file, while the media content is provided to the display device and played by the display device.

The embodiments described herein further include, but are not limited to, at least one computer-readable storage medium having a number of instructions configured to enable a mobile device, in response to execution of the instructions by the mobile device, to complement consumption of media content of a media file using a display device. The mobile device may be enabled to provide instructions to an adapter device configured to emulate a storage medium having one or more media files to a display device to capture one or more images from media content of a media file the adapter device provides to the display device to play, while the media content is being played by the display device, and to provide the one or more images after capture to the mobile device. Further, the mobile device may be enabled to facilitate one or more online transactions involving the one or more images or portions thereof.

In embodiments, the mobile device may be enabled to instruct the adapter device to include the one or more media files in a playlist to be presented to the display device emulating the storage medium, and to provide the adapter device with one or more locations to retrieve media content associated with the one or more media files to enable the adapter device, in response to a selection of one of the one or more media files by the display device, to provide the display device with the media content associated with the selected media file emulating the storage medium. In embodiments, the one or more online transactions may include one or more transactions with a remote search engine, an online social networking site, or an online e-commerce site.

The embodiments described herein further include, but are not limited to, a method for enabling consumption of media content using a display device, and complementing the consumption using a mobile device. The method may include providing, by an adapter device, to the display device a playlist of one or more media files emulating a storage medium having the one or more media files; and in response to a selection of one of the one or more media files by the display device, providing, by the adapter device, to the display device with media content associated with the selected media file emulating the storage medium. The adapter device may establish the playlist of one or more media files responsive to instructions from the mobile device, and retrieve the media content associated with the selected media file from the mobile device or a remote media server identified by the mobile device.

In embodiments, the method may further include pre-caching, by the adapter device, at least a portion of the media content associated with the selected media file from the remote media server, after receipt of instructions from the mobile device to include the media file as part of the playlist. The method may further include capturing one or more images of the media content of the selected media file, in response to instructions from the mobile device, while the media content is provided to the display device and played by the mobile device. The method may further include detecting, by the adapter device, removable mating of the adapter device with the display device.

The embodiments described herein further include, but are not limited to, a complementary method for enabling consumption of media content using a display device, complementing the consumption using a mobile device. The complementary method may include instructing, by the mobile device, an adapter device to capture one or more images from media content of a media file provided by the adapter device to a display device to play, while the media content is being played by the display device, and to provide the one or more images after capture to the mobile device. The adapter device may be configured to emulate a storage medium with one or more media files to the display device. The method may further include facilitating one or more online transactions involving the one or more captured images or portions thereof.

In embodiments, the method may further include instructing, by the mobile device, the adapter device to include the one or more media files in a playlist to be presented to the display device emulating the storage medium; and providing, by the mobile device, to the adapter device with one or more locations to retrieve media content associated with the one or more media files. The instructing and providing may enable the adapter device, in response to a selection of one of the one or more media files by the display device, to provide the display device with media content associated with the selected media file emulating the storage medium. In embodiments, the one or more online transactions may include one or more transactions with a remote search engine, an online social networking site, or an online e-commerce site.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the present disclosure. This application is intended to cover any adaptations or variations of the embodiments discussed herein. Therefore, it is manifestly intended that the embodiments of the present disclosure be limited only by the claims.

1. An apparatus for enabling consumption of media content using a display device and complementing the consumption using a mobile device, comprising:
a peripheral interface to couple the apparatus to the display device, emulating a storage medium having one or more media files; and
one or more logic units coupled to the peripheral interface to provide the display device with a playlist of the one or more media files, and in response to a selection of one of the one or more media files by the display device, provide the display device with media content associated with the selected media file emulating the storage medium;
wherein the one or more logic units are to establish the playlist of one or more media files responsive to instructions from the mobile device, and to retrieve the media content associated with the selected media file from the mobile device or a remote media server identified by the mobile device.

2. The apparatus of claim 1 further comprising one or more communication interfaces coupled to the one or more logic units to enable the one or more logic units to receive the instructions with respect to establishment of the playlist from the mobile device, or to retrieve the media content associated with the selected media file from the mobile device or the remote media server.

3. The apparatus of claim 2, wherein the one or more logic units are to further capture one or more images of the media content of the selected media file, in response to instructions from the mobile device, while the media content is provided to the display device and played by the display device.

4. The apparatus of claim 3, further comprising a local storage coupled to the communication interface and the one or more logical units to enable the one or more logical units to pre-cache at least a portion of the media content associated with the selected media file, after receipt of instructions from the mobile device to include the media file as part of the playlist.

5. The apparatus of any one of the preceding claims, wherein the one or more logic units comprise:
a messenger to receive the instructions from the mobile device; and
a media streamer to provide the display device with the playlist of one or more media files, to receive the selection of one of the one or more media files from the display device, and to provide the display device with media content associated with the selected media file, including retrieval of the media content associated with the selected media file from the mobile device or the remote media server.

6. The apparatus of claim 5, wherein the display device comprises a television having a complementary peripheral interface to enable the apparatus to be removably coupled with the television through the peripheral interface of the apparatus, and the one or more media files comprise one or more movies or one or more episodes of a show.

7. The apparatus of claim 4, wherein the local storage comprises a non-volatile persistent storage.

8. The apparatus of claim 2, wherein the one or more communication interfaces comprise one or more wireless communication interfaces, including a wireless personal network communication interface, a wireless local area communication interface, or a wireless wide area network communication interface.

9. The apparatus of claim 1, wherein the storage medium to be emulated is a memory card.

10. An apparatus for complementing consumption of media content using a display device, comprising:
a communication interface to communicatively couple the apparatus with an adapter device configured to emulate a storage medium having one or more media files to the display device; and
one or more logical units coupled to the communication interface to instruct the adapter device to capture one or more images from media content of a media file being provided from the adapter device to the display device to play, while the media content is being played by the display device, and provide to the apparatus with the one or more images after capture; and to facilitate one or more online transactions involving the one or more images or portions thereof.

11. The apparatus of claim 10, wherein the one or more online transactions comprise one or more transactions with a remote search engine, an online social networking site, or an online e-commerce site.

12. The apparatus of claim 10, wherein the one or more logical units are to further instruct the adapter device to include the one or more media files in a playlist to be presented to the display device emulating the storage medium, and to provide the adapter device with one or more locations to retrieve media content associated with the one or more media files, to enable the adapter device, in response to a selection of one of the one or more media files by the display device, to provide the display device with the media content associated with the selected media file emulating the storage medium.

13. The apparatus of claim 12, wherein the one or more logical units comprise:
a messenger unit to instruct the adapter device to include one or more media files in a playlist to be presented to the display device, and to provide the adapter device with one or more locations to retrieve media content associated with the one or more media files; and
a user application to enable a user to identify the one or more media files, to provide instructions to capture one or more images of the media content of the selected media file, through the adapter device, while the media content is being played by the display device, and to facilitate one or more transactions involving the one or more images or portions thereof, wherein the messenger unit is to further instruct the adapter device to capture the one or more images.

14. The apparatus of claim 13, wherein the user application is to facilitate the one or more transactions involving the one or more images or portions thereof through the communication interface, wherein the communication interface is a wireless local network communication interface.

15. The apparatus of claim 13, wherein the communication interface comprises a wireless personal network communication interface, wherein the messenger unit is to instruct the adapter device through the wireless personal network communication interface, and the apparatus further comprises a wireless local area network communication interface, wherein the user application is to facilitate the one or more transactions involving the one or more images or portions thereof through the wireless local area network communication interface.

16. (canceled)

17. The apparatus of claim 10, wherein the display device comprises a television having a peripheral interface to enable removable mating with the adapter device, and the one or more media files comprise one or more movies or one or more episodes of a show.

18. At least one non-transitory computer-readable storage medium having a plurality of instructions configured to enable an adapter device, in response to execution of the instructions by the adapter device, to emulate a storage medium with media files to a display device to enable consumption of the media files using the display device and complementing the consumption using a mobile device, including provision to the display device a playlist of one or more media files, and in response to a selection of one of the one or more media files by the display device, provision to the display device with media content associated with the selected media file emulating the storage medium, wherein the instructions, in response to execution of the instructions by the adapter device, enable the adapter device to establish the playlist of one or more media files responsive to instructions from the mobile device, and to retrieve the media content associated with the selected media file from the mobile device or a remote media server identified by the mobile device.

19. The at least one computer-readable storage medium of claim 18, wherein the instructions, in response to execution of the instructions by the adapter device, further enable the adapter device to pre-cache at least a portion of the media content associated with the selected media file from the remote media server, after receipt of instructions from the mobile device to include the media file as part of the playlist.

20. The at least one computer-readable storage medium of claim 18, wherein the instructions, in response to execution of the instructions by the adapter device, further enable the adapter device to capture one or more images of the media content of the selected media file, in response to instructions from the mobile device, while the media content is provided to the display device and played by the display device.

21. At least one non-transitory computer-readable storage medium having a plurality of instructions configured to enable a mobile device, in response to execution of the instructions by the mobile device, to complement consumption of media content of a media file using a display device, including provision of instructions to an adapter device configured to emulate a storage medium having one or more media files to a display device to capture one or more images from media content of a media file the adapter device provides to the display device to play, while the media content is being played by the display device, and to provide the one or more images after capture to the mobile device, wherein the instructions, in response to execution by the mobile device, further enables the mobile device to facilitate one or more online transactions involving the one or more images or portions thereof.

22. The at least one computer-readable storage medium of claim 21, wherein the instructions, in response to execution of the instructions by the mobile device, further enable the mobile device to instruct the adapter device to include the one or more media files in a playlist to be presented to the display device emulating the storage medium, and to provide the adapter device with one or more locations to retrieve media content associated with the one or more media files to enable the adapter device, in response to a selection of one of the one or more media files by the display device, to provide the display device with the media content associated with the selected media file emulating the storage medium.

23. The at least one computer-readable storage medium of claim 21, wherein the one or more online transactions comprise one or more transactions with a remote search engine, an online social networking site, or an online e-commerce site.

24. A method for enabling consumption of media content using a display device, and complementing the consumption using a mobile device, comprising:
providing, by an adapter device, to the display device a playlist of one or more media files emulating a storage medium having the one or more media files; and
in response to a selection of one of the one or more media files by the display device, providing, by the adapter device, to the display device with media content associated with the selected media file emulating the storage medium;
wherein the adapter device establishes the playlist of one or more media files responsive to instructions from the mobile device, and retrieves the media content associated with the selected media file from the mobile device or a remote media server identified by the mobile device.

25. The method of claim 24 further comprising pre-caching, by the adapter device, at least a portion of the media content associated with the selected media file from the remote media server, after receipt of instructions from the mobile device to include the media file as part of the playlist.

26. (canceled)

27. (canceled)

28. A method for enabling consumption of media content using a display device, complementing the consumption using a mobile device, comprising:
instructing, by the mobile device, an adapter device to capture one or more images from media content of a media file provided by the adapter device to a display device to play, while the media content is being played by the display device, and to provide the one or more images after capture to the mobile device, wherein the adapter device is configured to emulate a storage medium with one or more media files to the display device; and
facilitating one or more online transactions involving the one or more captured images or portions thereof.

29. The method of claim 28 further comprising instructing, by the mobile device, the adapter device to include the one or more media files in a playlist to be presented to the display device emulating the storage medium; and providing, by the mobile device, to the adapter device with one or more locations to retrieve media content associated with the one or more media files, wherein the instructing and providing enable the adapter device, in response to a selection of one of the one or more media files by the display device, to provide the display device with media content associated with the selected media file emulating the storage medium.

30. (canceled)
